(19) United States
(12) Patent Application Publication
(10) Pub. No.: US 2024/0109561 A1
(43) Pub. Date: Apr. 4, 2024

(54) DYNAMIC ADAPTIVE SITE GATING USING VEHICLES

(71) Applicant: FORD GLOBAL TECHNOLOGIES, LLC, Dearborn, MI (US)

(72) Inventors: Stuart C. SALTER, White Lake, MI (US); Adam WINT, Plymouth, MI (US); Brendan F. DIAMOND, Grosse Pointe, MI (US); Meghan PREISS, Detroit, MI (US); Pietro BUTTOLO, Dearborn, MI (US); Lia PILLEN, Woodhaven, MI (US)

(21) Appl. No.: 17/956,152

(22) Filed: Sep. 29, 2022

(51) Int. Cl. B60W 60/00; B60Q 5/00; G07C 9/10; G08G 1/00

(52) U.S. Cl. CPC B60W 60/0025; B60Q 5/005; G07C 9/10; G08G 1/22; B60W 2420/42; B60W 2556/45

(57) ABSTRACT

A system receives a request for gate formation, including indication of a location where one or more vehicles are to form a gate. The system determines a number of vehicles to form the gate. The system also determines available vehicles in proximity to the location and, responsive to the available vehicles including at least the number of vehicles, selects the number of vehicles from the available vehicles to serve as gate vehicles. Also, the system instructs the gate vehicles to autonomously travel to the location and arrange in a designated formation, included in the instruction, to form the gate.

### TECHNICAL FIELD

The illustrative embodiments generally relate to methods and apparatuses for dynamic adaptive site gating using vehicles.

### BACKGROUND

Vehicles are frequently present at job and construction sites, and are often sitting idle while workers perform their daily tasks. These vehicle, when modern, often have a great deal of usable computing and other technology, and are effectively massive powerful computers and sensors sitting idle at a site.

As the vehicles become capable of autonomous or semi-autonomous driving, they are capable of independent movement about a site, and if their resources are desired, they can be dispatched to site locations where they are useful, without requiring a driver.

Human personnel are very useful to site progression, but they also have the conventional shortcomings associated with biological entities—they can get sick, they can be late, they can quit unexpectedly, etc. Vehicles that are repurposable for many roles can assist in temporary or long term solutions to these issues. Enhanced vehicle capabilities render them suitable for many tasks, especially on a short-term basis. Having physical characteristics that are different from humans means that vehicles can also perform certain tasks humans cannot, such as tasks that leverage their size, weight, power and/or the fact that they are not subject to exposure to adverse conditions in the same manner as humans (e.g., they can travel through a toxic environment often without issue).

### SUMMARY

In a first illustrative embodiment, a system includes one or more processors configured to receive a request for gate formation, including indication of a location where one or more vehicles are to form a gate. The one or more processors are also configured to determine a number of vehicles to form the gate. The one or more processors are further configured to determine available vehicles in proximity to the location and, responsive to the available vehicles including at least the number of vehicles, select the number of vehicles from the available vehicles to serve as gate vehicles. Also, the one or more processors are configured to instruct the gate vehicles to autonomously travel to the location and arrange in a designated formation, included in the instruction, to form the gate.

In a second illustrative embodiment, a vehicle includes one or more processors configured to receive instructions to form a gate, including a gate location and a designation of the vehicle as a gatekeeper. The one or more processors are also configured to drive the vehicle to the location and position the vehicle to block an access point at the location, in accordance with the instructions. The one or more processors are further configured to determine the approach of at least one entity seeking access through the access point and utilize at least one vehicle sensor to verify permissibility of access for the at least one entity. Further, the one or more processors are configured to, responsive to verification of permissibility, move the vehicle to a position allowing the at least one entity access through the access point.

In a third illustrative embodiment, a system includes a first vehicle, including one or more first processors, and one or more second vehicles, including one or more second processors, wherein the one or more first processors are configured to receive instructions for the first vehicle to act as a gatekeeper vehicle in a formation at a location, designated in the instructions, wherein the formation includes the first vehicle and the one or more second vehicles and forms a gate across an access point at the location. The one or more first processors are also configured to receive a request for access to the access point, determine a validity of the request, and provide access through the access point, by movement of the first vehicle and instruction to the one or more second vehicles to move, responsive to the request being determined valid. The one or more second processors are configured to move the one or more second vehicles to the location into formation in accordance with instructions from the first vehicle, and move the one or more second vehicles out of formation in accordance with instructions from the first vehicle.

### BRIEF DESCRIPTION OF THE DRAWINGS

FIG. 1 shows an illustrative example of a vehicle as a gate system;

FIG. 2 shows an illustrative example of a gate coordination process;

FIG. 3 shows an illustrative example of a gate control process;

FIG. 4 shows an illustrative example of a guard-replacement process; and

FIG. 5 shows an illustrative example of an exit-analysis process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments propose adaptive mobile gates creatable by use of autonomous or partially autonomous vehicles on a jobsite. Because a construction site often has numerous openings and areas of ingress, especially when heavy equipment is being moved on and off-site frequently, it can be difficult to monitor and control access to the site. Setting up temporary gates and access points can require a lot of resources, and those will all eventually have to be removed and moved to other locations. Gates include impediments across or blocking any point of ingress or egress, partially or fully, but intentionally, and obstacles restricting access to areas reachable by travel through the ingress or egress.

The illustrative embodiments propose the use of vehicles to create temporary gates. Vehicles work alone or in concert with each other to create blockages and impediments to site entry. For a short span or gap, a single vehicle may suffice, but larger spans may be coverable by groups of vehicles working together. This also means that if a fence is removed, for example, the vehicles can create a new, larger gate, with minimal additional hassle.

Since vehicles are usually more expensive than gate hardware, it may not be preferable to use vehicles exclusively for this purpose. But, when the vehicle is onsite in any event, and especially when the vehicle is provided with capability to assist onsite in many other capacities, using the vehicles as gates when needed is very convenient.

Vehicles can also serve as temporary gate guards, using onboard sensing and detection capabilities, as well as AI when available, to provide gate control functions while a guard is on break, or if a guard doesn't show up for a shift. The vehicle can process wireless credentials, and/or can simply instruct control of the lift gate of a gate, responsive to, for example, an onsite gate computer verifying a credential. The vehicle, like a guard, can also use sensing to notice inappropriate behavior and notify the proper parties, and the vehicle can even move itself to block entry or exit of other vehicles, when necessary, as a secondary backup measure to a gate. Further, vehicles cannot be threatened or intimidated by someone with nefarious intentions.

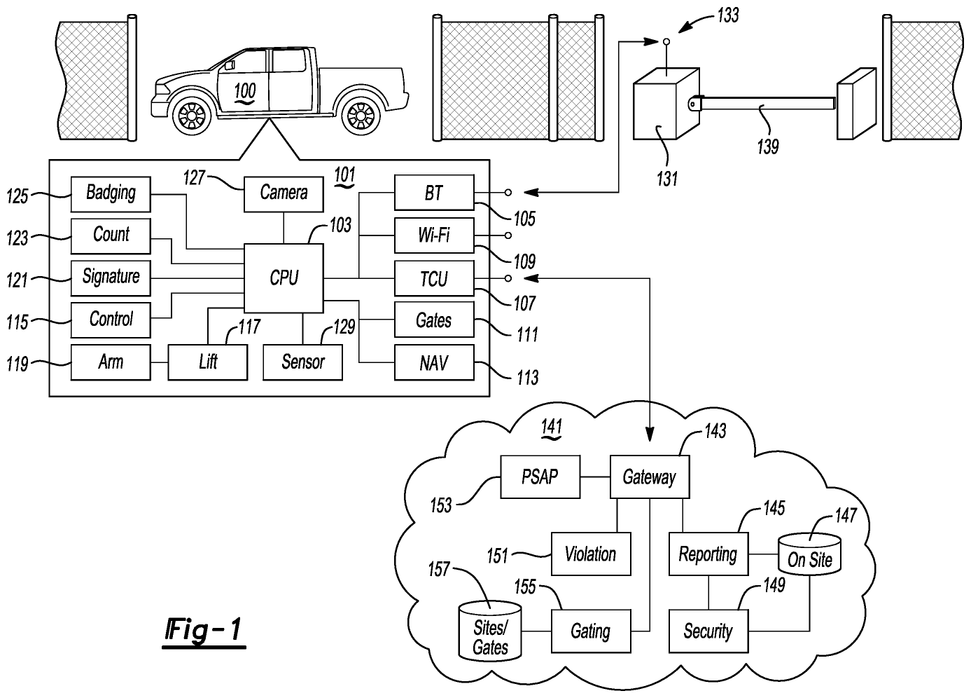

FIG. 1 shows an illustrative example of a vehicle as a gate system. In this example, a vehicle 100, or a group of vehicles acting in concert, can form a mobile barricade across a gap at a jobsite. The gap can be in a fence, between buildings, or even simply involve blocking access to equipment by fully or partially surrounding the equipment. For example, if there was a fear that materials or heavy equipment could be moved offsite, the vehicles 100 could form impediments to either, by blocking parking near the material to prevent fast loading of stolen material, or by blocking the ability to easily drive heavy equipment offsite. In this regard, vehicles may make ideal proxies for gates in certain instances, as they are heavy, bulky obstacles that can easily move to wherever they are suited for deployment. When the vehicles are fully or semi autonomous, the notion of an automatic adaptive, reactive gate can be fully realized without reliance on or expense of additional personnel.

The example vehicle has an onboard computing system 101 with one or more processors 103. The vehicle 100 also includes communication capabilities, such as a BLUETOOTH transceiver 105, a telematics control unit (TCU) 107, and a Wi-Fi transceiver 109. The vehicle can be controlled or directed through onboard commands or remote commands, received from a transceiver, to deploy itself as one or more mobile gates as needed throughout a day.

For example, a gates process 111 may have a list of stored locations where the vehicle is supposed to be performing gate duties throughout the day. The vehicle may have additional purposes, such as traveling about the construction site and assisting with other tasks, and then at certain hours, such as lunch and afterhours, the vehicle 100 may function as a gate to the site. The vehicle 100 can also be dynamically repurposed as a gate at any time, and an onboard navigation function 113 can help direct the vehicle 100 to the designated gating location and help align the vehicle 100 with any requested headings.

A control process 115 can use local communication, such as BLUETOOTH or Wi-Fi, to command local gates 131 to open and close. For example, a vehicle 100 can serve as a temporary gate guard while a human guard goes on a break. The vehicle 100 may be equipped with cameras or other sensors capable of recognizing and verifying approved entrants, and may use the control function 115 to instruct lifting of a more permanently deployed gate arm 139, thorough wireless communication 133. That way, the site, which may typically rely on human review of credentials, does not need to deploy expensive credential verification equipment for times when a guard is not available, and instead can rely on the vehicle 100 and its sensing capability to serve in the capacity of a human guard as needed. Because the vehicle 100 also has long range and shorter range communication capability, it can also communicate with a remote human or computer for override purposes, such as instances where an approved person forgot their verifiable credentials, but where a remote system or operator can instruct override. Again, since this functionality is included in the vehicle, it can be moved about where needed and mitigate the expense of installing permanent or semi-permanent equipment to serve in this capacity.

In still another embodiment, the vehicle 100 may be equipped with a mobile arm 119 and a lift control 117. This allows the vehicle 100 to function as a literal gate comparable to those that might be already deployed onsite. This also allows the vehicle to permit ingress more easily, as it will not have to move to allow passage, and may provide suitable gating options for high traffic areas and/or areas where continual vehicle movement may be undesirable. Similar to the other embodiments, the vehicle 100 can still be moved where needed to block access. If a more robust gate is needed than the arm 119 provides, the vehicles can move itself across the path of entry or exit. This effectively creates a fast working gate for low security situations with the ability to “harden” the gate if needed by moving a heavy vehicle across the path, again without any need to install permanent features. And, because vehicles can act in concert, vehicles can stack themselves laterally across a path to increase the “hardening” of the gate even more, which may allow them to prevent exit of even large construction equipment by simply creating too much of a barrier for the equipment to overcome.

The vehicle 100 may further be able to receive delivery packages when authorized, in the same manner as a guard. The vehicle 100 may include capability to remotely sign for packages with an authorized signature 121, after, for example, verifying contents and/or shipping labeling on the package with a vehicle camera. Then the vehicle 100 can sign for the package and the delivery person may even leave the package in the vehicle, allowing for easier later delivery by the vehicle 100 to an onsite location.

The vehicle 100 may also include a counting process 123 that takes inventory of vehicles and/or people entering and exiting a site. This allows the vehicle 100 to confirm that everyone who came onsite during the day is properly offsite at a day's end. This process may also leverage vehicle cameras 127 and/or other sensors 129 to help verify the conditions of vehicles entering and exiting a site. For example, a camera can view a loaded vehicle entering a site that is supposed to be unloaded during the day. When the same vehicle is exiting the site, if the suspension and ride-height seems to indicate that the vehicle is still loaded, the gate vehicle 100 can issue a stop command or other notification to proper entities to ensure that the vehicle was unloaded and/or that nothing is being stolen by the exiting vehicle.

Finally, in this example, the vehicle 100 can issue badging 125 for entering vehicles or personnel. This can include issuance and deployment of physical badges that have RFID transponders, for example, allowing for tracking of vehicles and personnel onsite. In another example, the vehicle 100 could issue unique codes to applications executing on entering vehicle computers and/or personnel mobile devices, allowing for tracking of the unique IDs as the vehicle or personnel moved about the site. Installation and execution of such an application may be mandated for site entry, and premature termination of the application could result in notification to authorities. This allows for tracking and badging without reliance on expensive additional equipment. Vehicles throughout the site, in communication with the badged entities, can track movement without requiring additional tracking equipment, and/or traveling vehicles 100 performing various functions can simply spot-communicate with local badge processes executing on phones or in-vehicle for badged vehicles. If an entity cannot present a badge verification upon request, the vehicle 100 can notify the appropriate parties and/or block passage if the badged entity is a vehicle.

The vehicle 100 may use longer range communication, such as that provided by TCU 107, to communicate with a cloud-based system 141. The system may be provided by an original equipment manufacturer (OEM) and may include a variety of functionality. Accordingly, a gateway process 143 may correctly direct requests and responses to the general OEM backend.

In this example, the backend may include reporting processes 145 for reporting the presence (entry and/or exiting) of entities through vehicle-controlled gates. The backend can maintain a list of the people and vehicles onsite 147, as well as provide backup security processes 149 if the vehicle 100 reports an incident. If the vehicle detects a high-threat violation, it can report the violation to an emergency process 151, which can immediately contact a public enforcement entity 153.

Further, the cloud can store longer term gating instructions for a site 157, which can include where and when a vehicle 100 is commonly to be deployed as a mobile dynamic gate for a given site. This can include time-based instructions (e.g., deploy at location X from 10-11 AM), instructions for guard relief (control Y gate from 11:15-12:15), etc. The gate indication may also include how many vehicles 100 are included in a gate based on distance and/or vehicle count. A backend process 155 can coordinate vehicles and issue commands, or vehicles 100 onsite can work in concert if more than one is needed to provide mobile blockage.

Vehicles 100 can work in concert to provide gating if larger areas need gating. If vehicles are insufficient in count and availability to fully block a path, they can strategically deploy using onsite sensing to create passage areas that are, for example, at least too small for another vehicle to pass. Since they are mobile, even fewer vehicles than are completely needed can effectively block a path by moving to more directly impede passage of an unauthorized vehicle as it approaches a point—the vehicle 100 can use sensors to effectively intercept the unauthorized vehicle and block passage.

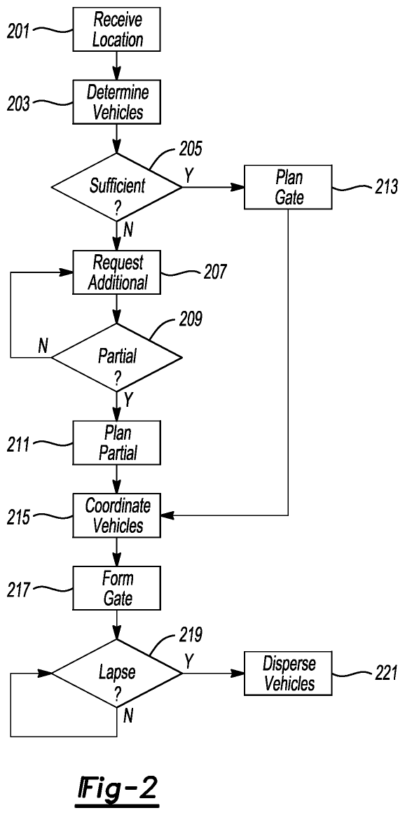

FIG. 2 shows an illustrative example of a gate coordination process. In this example, the coordination process, which can execute onsite at a server, between vehicle computers onsite, or in the cloud, receives a location to be blocked at 201. This can also include additional instructions, such as who or what to allow through (including either classes of entrants, e.g. personnel, vehicles, and/or specific identities), and time parameters for how long a gate is designated to exist.

The process can determine if sufficient onsite vehicles exist to form the gate at 203, which can include the dimensions, weights, etc. of onsite vehicles as well as whether those vehicles 100 have any other designated tasks at any time during a duration of the gating period. Idle vehicles may also be repurposable for additional tasks as needed during the gating period, which can result in temporary reconfiguration of a gate until a given vehicle that must leave completes its temporary task.

If there are insufficient vehicles to form a full gate at 205, which can include even a lacking single vehicle for a one-vehicle gate, if all possible gate vehicles are being used for other purposes, the process can request additional vehicles at 207. This can include, for example, asking a backend process to send one or more additional vehicles to the site, or can include queuing on one or more local vehicles in order to have one or more of those vehicles come assist in the gate handling when any current tasks are completed and those vehicles are available for gate duty. Depending on gate priority relative to current task priority, one or more requested vehicles may be immediately repurposed to a high priority gate if it is currently engaged in a task designated as lower priority. Sufficiency of vehicles may also be dependent on whether at least one vehicle includes capability to check credentials of entrants, if that functionality is needed.

If there are enough vehicles to form a partial gate at 209, and/or if a partial gate is appropriate, the process can plan alignment for a partial gate at 211. For example, if five vehicles were requested to block a 40 foot span, a single vehicle may be insufficient to partially gate the span, and so the single vehicle may either be sent to the gate location to await assistance, or be temporarily left to execute other tasks. When at least three vehicles, in this example, are available, a temporary gate can be formed. If each vehicle is 8 feet long, then a gate can be formed with approximately 3 foot gaps at the ends and between vehicles. That space should at least prevent entry of other vehicles, making the temporary gate suitable. Suitability of a given temporary gate may be defined by a gate requestor—for example, even with a 40 foot span and a single vehicle, the single vehicle could at least actively record passing parties, even if it could not impede them, providing at least some measure of security. The example shown requiring three vehicles was merely to demonstrate how an inadequate gate under one definition cold be partially completed without requiring all vehicles to be available and present.

Similarly, if sufficient vehicles are available at 205, the process can plan the intended gate at 213, which can involve determining which vehicles should comprise which components of a gate based on, for example, vehicle weight, size, maneuverability, etc. If all vehicles are the same, or if an operator does not care about gate composition, then the planning may simply be to provide the vehicles 100 with operating instructions so they do not all attempt to occupy the same gate section. In other examples, more maneuverable vehicles could comprise the “operational” part of a gate with bulkier vehicles comprising the end posts. That would allow for faster access, and the bigger vehicles could move towards each other if a more rigorous blockade were needed.

The process coordinates the identified vehicles at 215, to provide operational instructions, gate element assignments, etc. This coordination can also indicate duration of a gate and which vehicles, if fewer than all, are to move when a vehicle approaches for entry. The coordination process can also provide assignments for which vehicle performs authentication, security notifications, etc.

The vehicles 100 then work in concert to form the instructed gate at 217. This can involve vehicles stacking in a line end-to-end, adjacent side-to-side, etc. Vehicles can move into any desired configuration that space permits, and act in concert to open a gate when entry is permitted. Onboard autonomous and semi-autonomous systems (such as cooperative driving systems and obstacle circumvention systems) can work to provide gating functions in the absence of human drivers. Until a time when a gate is to lapse at 219, the vehicles can remain in gate formation. If a vehicle is needed for another task that has higher priority than the gate, it can leave the formation and the formation can either reform if sufficient vehicles remain, or disperse. Vehicles 100 also disperse when the gate is lapsed due to expiration at 221.

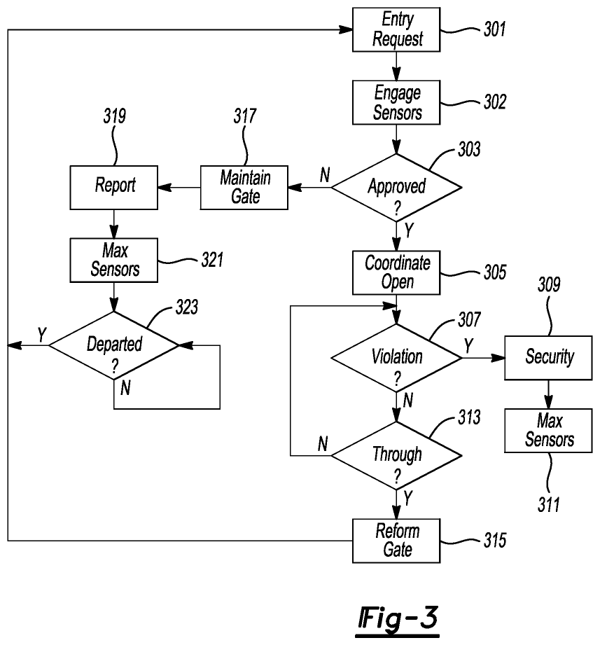

FIG. 3 shows an illustrative example of a gate control process. In this example, an entity requests entry and a vehicle receives the request at 301. This can include vehicle to vehicle (V2V) requests sent from one vehicle computer to another, if the entering vehicle stores credentials that can be verified. In other examples, a user can provide a cellular request through an application, or a physical badge for access, or use their face, fingerprint, etc. to prove their identity. Based on the type of credentialing used, an appropriate vehicle may be included in the gate, with capability to detect and analyze the received credentials. If analysis is not possible, the cloud can assist in analysis, and the vehicle can act as a credential relay between the entering party and the cloud.

In this example, the vehicle 100 engages the appropriate sensors at 302 to receive credentialing data and determines at 303 if the entrant is approved. If the entrant is approved, the vehicle or vehicles coordinate an opening process at 305, which can involve ordered maneuvering of vehicles to create ingress sufficient for an entrant. By controlling passage width, which is a feature not often available to static gates, vehicles can also help prevent tailgaters from slipping through a gate. For example, if a person is walking onto the site, the passage need not be sufficient to allow entrance of even a single vehicle. Other passage width can be tuned such that only narrower vehicles could tailgate, and even in that instance it is unlikely the tailgating would go unnoticed. Sensors can include, for example, wireless radio frequency detection, cameras, IR cameras, LIDAR, RADAR, microphones, etc.

If there is a violation upon entry at 307, such as a tailgater, the process can notify security at 309 and engage maximum sensing on all present (and possibly other site) vehicles at 311 to track, record and capture all relevant data related to the violation. This can provide accurate onsite tracking of any offender, as well as provide ample evidence for later prosecution if needed. Other violations could include detected load violations encountered by sneaking people or items on or off a site, or false credentialing that appeared legitimate but did not correspond to an observed vehicle passing through the gate.

Once the approved vehicle is through the gate at 313, the vehicles forming the gate can work to reform the gate at 315. It is also possible to physically stop a vehicle from passage by using the unmanned gate vehicles, but this may be done with caution to prevent any issues caused by driving one unmanned vehicle into another that may be manned, even if justified.

If the entry is denied at 303, the vehicles 100 can maintain the gate at 317 and notify onsite personnel or remote personnel at 319, in case an override is desired. The vehicle 100 doing the credentialing can provide communication and scanning capability for override requests, if needed. All onsite vehicles at the gate and/or elsewhere can max sensors at 321, responsive to the denied entry, in order to track any subsequent attempts at forced entry by the denied entrant. Enhanced sensor engagement may last until the entrant is determined to have departed the gate entrance at 323.

Vehicles working to move and reform the gate can also use the sensors to detect the locations of other gate vehicles, to create appropriate formations—that is, if a vehicle is 3^{rd} in a row of 4 vehicles forming a gate, the vehicle coordinates for the 3^{rd} location may not be exact, but rather a 1^{st} vehicle can position itself within 6 inches of a fence, a second vehicle within 1 foot of the rear of the 1^{st} vehicle, etc., to minimize ingress while leaving sufficient room for the vehicles to move out of the way. A middle vehicle could even be in an offset formation, so it could move backwards and forwards to “slide” open the gate, with the end vehicles forming more of a permanent barrier unless a very large vehicle needed passage.

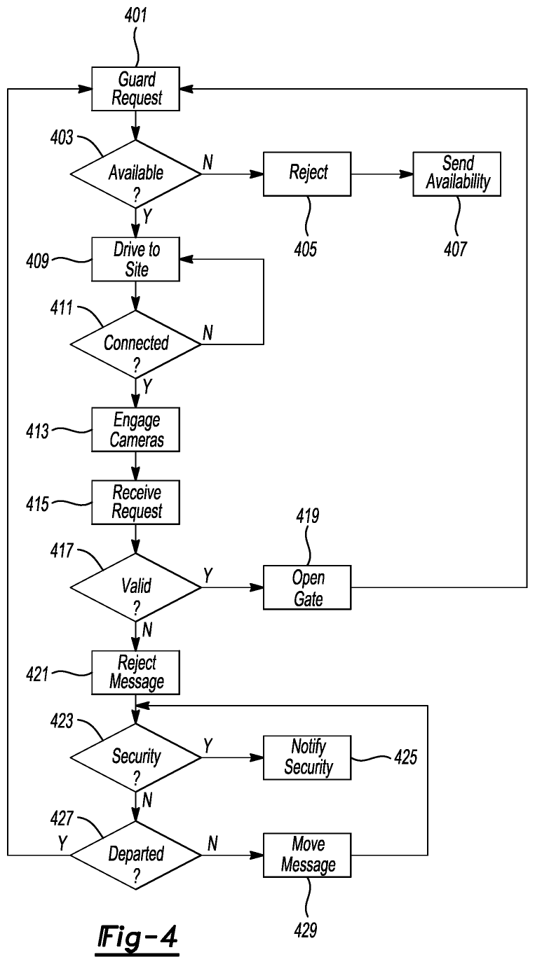

FIG. 4 shows an illustrative example of a guard-replacement process. Instead of being a scheduled replacement, which is also possible, this is an example of a dynamic replacement request, such as when a guard may need a restroom break or need to leave for other reasons. On site vehicles can be immediately retasked with guard duty in the manner proposed, as well as being scheduled for similar guard duty.

When a vehicle, group of vehicles, onsite or offsite (e.g. cloud) coordination process receives the request at 401, it determines if a vehicle is available at 403. For example, if the request were received by a plurality of onsite vehicles, they could communicate in case any vehicle was available, so multiple vehicles were not tasked when only one was needed. The request may have priority associated therewith as well, a guard taking a smoking break may have low priority, a guard with a medical emergency who has to leave may have high priority.

If no vehicles are available based on the request and any associated priority at 403, the process may reject the request at 405 and notify the guard of the rejection, as well as any future availability, at 407. The guard may also be able to queue the request with a vehicle to plan for a future break, or at least knows when to resubmit the request for vehicle assistance.

If a vehicle 100 is available at 403, the vehicle 100 can drive to the guard location at 409. Presumably, the guard either has a manually controlled gate or a computer controlled gate at the location, and in those instances the vehicle 100 can wirelessly connect to the gatehouse computer and/or physical controls when in suitable proximity at 411.

Once the vehicle is connected and/or onsite at 411, the vehicle can enable its own cameras and other sensors at 413, in case they are needed for onsite credential verification. If the vehicle receives a valid entry request at 415, and verifies the request at 417, the vehicle can instruct the gate to open at 419. This can include a wireless command or even physical lifting of the gate with a vehicle armature, if the vehicle is suitably equipped and that is how the gate is opened. If the vehicle cannot lift a manual gate arm, the guard may open the gate until the guard returns, and the vehicle 100 can instead form a physical barrier across the opening, acting effectively as the gate arm. This obviates a need for having too many overly specialized vehicle upfits onsite, unless they are desired for some reason.

If the request is invalid at 417, the process can send or issue a reject message at 421. For example, if the request came from V2V or device to vehicle communication, the rejection could be sent to the transmitting entity. If the request was in the form of imaging from a vehicle camera, voice recognition, entry of a biometric, etc., then the vehicle 100 could issue the rejection audibly through a vehicle 100 audio system. The vehicle 100 could also notify security at 425 if onsite behavior by the entrant dictates such notification at 423.

For example, a vehicle could reject entry and the entity could refuse to move. If the entity does not depart at 427, the vehicle 100 could issue a “please move away from the gate” message in a manner similar to the reject message, and/or in a manner more aggressive than the rejection message or that increases with number of times issues or the passing of time. At some point, if the entity does not move, the vehicle 100 can engage security at 423. Once a guard returns, the vehicle 100 can leave and perform other site duties as appropriate.

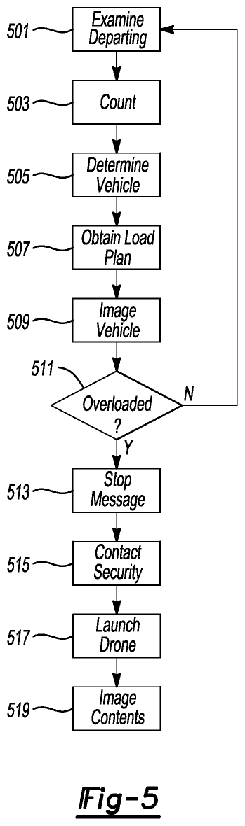

FIG. 5 shows an illustrative example of an exit-analysis process. This is a process wherein a vehicle can analyze incoming and exiting traffic to ensure, for example, that an exiting vehicle is not overloaded (indicating possible theft). As vehicles come onsite, the gate-handling vehicle can not suspension levels, etc., as well as note any loads that should theoretically be unloaded onsite. When vehicles are departing the site, the vehicle 100 can image or otherwise scan the departing vehicles at 501.

The vehicle 100 can remove the departing vehicle from an on-site count of vehicles at 503, which is a fast and effective way to ensure no inappropriate vehicles remain onsite. The vehicle 100 can also determine which given vehicle is exiting at 505, through wireless communication, general viewing of vehicle features, examining a license plate, etc.

The vehicle 100 can then access a load plan for the departing vehicle 507. For example, pickup trucks may be used for personnel transport and have an acceptable departure load based on personnel and light equipment. Freight trucks may have a plan indicating that they should be fully empty upon exit (or not empty) and the load analysis will accommodate any remaining loads indicated by the plan. The vehicle 100 can image or otherwise scan the departing vehicle at 509 to examine, for example, suspension loading. If the vehicle appears overloaded at 511, the gate vehicle 100 can issue a “Stop” message at 513. This can be a digital message, an audible message, a visual message on a vehicle or other display, etc.

The vehicle 100 can also contact onsite or offsite security at 515, in case the offending vehicle attempts to flee. Further, if so equipped, the gate vehicle 100 can launch a drone at 517, which can more closely examine the contents of the stopped vehicle at 519, such as by flying over or entering cargo areas or truck beds, to determine if the load resulted from appropriate or inappropriate materials being onboard the truck. Both the gate vehicle 100 and the drone can provide live feeds to any security personnel for saving for evidence as well as to convey any urgency associated with a given situation.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A system comprising:
one or more processors configured to:
receive a request for gate formation, including indication of a location where one or more vehicles are to form a gate;
determine a number of vehicles to form the gate;
determine available vehicles in proximity to the location; and
responsive to the available vehicles including at least the number of vehicles, select the number of vehicles from the available vehicles to serve as gate vehicles; and
instruct the gate vehicles to autonomously travel to the location and arrange in a designated formation, included in the instruction, to form the gate.

2. The system of claim 1, wherein the request includes a length of the gate.

3. The system of claim 1, wherein the instruction includes designation of a vehicle to perform a gatekeeper role.

4. The system of claim 3, wherein the gatekeeper role includes use of at least one vehicle system to autonomously verify credentials of at least one entity seeking passage through the gate.

5. The system of claim 1, wherein the one or more processors are configured to determine if the available vehicles meet a minimum number of vehicles to form the gate, responsive to the available vehicles including less than the number of vehicles.

6. The system of claim 5, wherein the one or more processors are configured to select all available vehicles responsive to the available vehicles meeting the minimum number of vehicles.

7. The system of claim 5, wherein the minimum number of vehicles is determined based at least on a length of the gate and lengths of the available vehicles.

8. A vehicle comprising:
one or more processors configured to:
receive instructions to form a gate, including a gate location and a designation of the vehicle as a gatekeeper;
drive the vehicle to the location;
position the vehicle to block an access point at the location, in accordance with the instructions;
determine the approach of at least one entity seeking access through the access point;
utilize at least one vehicle sensor to verify permissibility of access for the at least one entity; and
responsive to verification of permissibility, move the vehicle to a position allowing the at least one entity access through the access point.

9. The vehicle of claim 8, wherein the vehicle sensor includes a camera.

10. The vehicle of claim 8, wherein the vehicle sensor includes a radio frequency receiver or transceiver.

11. The vehicle of claim 8, wherein the one or more processors are further configured to move the vehicle based on a determined size of the entity, to control a size of the access granted through the access point based on the determined size.

12. The vehicle of claim 11, wherein the one or more processors are further configured to determine the size of the entity based on data received from at least one of the at least one vehicle sensors.

13. The vehicle of claim 8, wherein the instructions include a gate formation including a plurality of vehicles and a location of the vehicle in the gate formation.

14. The vehicle of claim 13, wherein the one or more processors are further configured to wirelessly instruct movement of at least another vehicle other than the vehicle in the gate formation, responsive to verification of permissibility.

15. The vehicle of claim 14, wherein the one or more processors are further configured to audibly instruct movement of the entity away from the access point, responsive to non-verification of permissibility.

16. The vehicle of claim 15, wherein the one or more processors are further configured to:
determine that the entity has not moved away from the access point, following a threshold time period after the audible instruction; and
responsive to the entity not moving away from the access point following the threshold time period, engage at least one security alert.

17. The vehicle of claim 8, wherein the one or more processors are further configured to count a number of entities entering and exiting through the access point during a predefined timespan, and issue an alert responsive to the number of entities exiting not being an expected number based on the number of entities entering.

18. The vehicle of claim 8, wherein the one or more processors are further configured to utilize one or more of the at least one vehicle sensors to determine whether a vehicle exiting through the access point is carrying a load greater than a predefined expected load.

19. The vehicle of claim 18, wherein the determination whether the vehicle exiting is carrying the load greater than the predefined expected load is based at least in part on observation of a ride height of the vehicle exiting as observed by the one or more sensors.

20. A system comprising:
a first vehicle, including a first one or more processors; and
one or more second vehicles, including one or more second processors, wherein
the first one or more processors are configured to:
receive instructions for the first vehicle to act as a gatekeeper vehicle in a formation at a location, designated in the instructions, wherein the formation includes the first vehicle and the one or more second vehicles and forms a gate across an access point at the location;
receive a request for access to the access point;
determine a validity of the request; and
provide access through the access point, by movement of the first vehicle and instruction to the one or more second vehicles to move, responsive to the request being determined valid, and wherein
the one or more second processors are configured to:
move the one or more second vehicles to the location into formation in accordance with instructions from the first vehicle; and
move the one or more second vehicles out of formation in accordance with instructions from the first vehicle.
